(19) United States
(12) Patent Application Publication
(10) Pub. No.: US 2026/0146676 A1
(43) Pub. Date: May 28, 2026

(54) T-Slot Operational Interface for an Oil and Gas Valve

(71) Applicant: Bestway Oilfield, Inc., Channelview, TX (US)

(72) Inventors: Don Channing Gramlich, Richmond, TX (US); Mehul Jain, Humble, TX (US)

(21) Appl. No.: 19/178,816

(22) Filed: Apr. 14, 2025

Related U.S. Application Data
(60) Provisional application No. 63/689,576, filed on Aug. 30, 2024.

(51) Int. Cl. F16K 3/314; F16K 3/02; F16K 27/04

(52) U.S. Cl. CPC F16K 3/314; F16K 3/0254; F16K 27/044

(57) ABSTRACT

A gate valve includes a valve body having a through-bore and gate a cavity that are substantially perpendicular to each other; an upper bonnet coupled to the valve body; an operator housing coupled to the valve body; a gate slidably disposed within the gate cavity; a piston, at least partially disposed within an interior cavity of the operator housing; an operator coupled to a first end of the piston; an operating stem, at least partially disposed within the gate cavity, an upper bonnet interior cavity, and the operator housing interior cavity. The operating stem is coupled to the piston and to the gate. The operating stem is coupled to the piston with a free floating connection to provide lateral movement of the operating stem relative to the piston. A t-shaped adapter may be used to connect the operating stem to the piston in a free floating manner.

### RELATED APPLICATION

This application claims the benefit of U.S. Provisional Patent No. 63/689,576, filed on Aug. 30, 2024, entitled, “T-Slot Operational Interface for Oil and Gas Valve,” the disclosure of which is hereby incorporated by reference for all purposes.

### TECHNICAL FIELD

This application is directed, in general, to valves for use in fluid transfer applications, and more specifically to t-slot operational interfaces for oil and gas valves.

### BACKGROUND

The following discussion of the background is intended to facilitate an understanding of the present disclosure only. It should be appreciated that the discussion is not an acknowledgement or admission that any of the material referred to was part of the common general knowledge at the priority date of the application.

Gate valves are used to control the transfer of fluids in tubing and pipelines. Specifically, gate valves are typically used to stop and start the flow of fluids in a downstream direction. Gate valves are commonly used in the oil and gas industry to control the flow of various fluids such as production fluids, water, fracking fluids, and other fluids used in drilling, operating, and maintaining oil and gas wells.

Gate valves generally operate by actuation of an internal gate, which in one position has an opening to allow upstream fluids to flow through the valve and in a downstream direction and a second position which blocks flow through the valve thereby preventing transfer of fluid in a downstream or upstream direction. While gate valves have been in existence for a long time, improvements are still desired.

### SUMMARY

In one illustrative embodiment, a gate valve includes a valve body; a gate disposed within the gate cavity; and a t-slot operating assembly at least partially disposed within the gate cavity. The t-slot operating assembly includes an operating stem having a first end and a second end; a piston having a t-slot aperture; and a t-slot adapter disposed within the t-slot aperture having an aperture sized and configured to receive the first end of the operating stem and having an external t-shape sized and configured to be received within the t-slot aperture of the piston. The second end of the operating stem is coupled to the gate. The valve body is formed with a through-bore therethrough and a gate cavity. The through-bore and the gate cavity intersect and are orthogonal to each other. The gate is operable to translate along a length of the gate cavity to move between an open position and a closed position. When the gate is in the closed position, the gate substantially blocks fluid flow through the through-bore. When the gate is in the open position, the gate does not substantially block fluid flow through the through-bore.

In one illustrative embodiment a gate valve includes a valve body; a gate disposed within the gate cavity; an operating stem at least partially disposed within the gate cavity and attached to the gate; a piston attached to the operating stem; and an operator attached to the piston. The valve body is formed with a circular through-bore therethrough and a gate cavity.

The through-bore and the gate cavity intersect and are orthogonal to each other. The gate is operable to translate along a length of the gate cavity to move between an open position and a closed position. When the gate is in the closed position the gate substantially blocks fluid flow through the through-bore. When the gate is in the open position the gate does not substantially block fluid flow through the through-bore. The operator is operable to move the gate between the open position and the closed position. The operating stem is attached to the piston with a t-slot connection.

In one illustrative embodiment a gate valve includes a valve body having a through-bore formed therethrough in a first direction and having a gate a cavity formed there through in a second direction; an upper bonnet coupled to the valve body, having an interior cavity; an operator housing coupled to the valve body, having an interior cavity; a gate slidably disposed within the gate cavity; a piston, at least partially disposed within the interior cavity of the operator housing, having a first end and a second end; and an operator coupled to the first end of the piston; an operating stem, at least partially disposed within the gate cavity, the upper bonnet interior cavity, and the operator housing interior cavity. The gate cavity and the through-bore are substantially perpendicular to each other. The gate cavity and the through-bore intersect with each other. A first end of the operating stem is coupled to the second end of the piston, and a second end of the operating stem is coupled to the gate. The operating stem is coupled to the piston with a free floating connection.

Other embodiments are disclosed.

### DESCRIPTION OF THE DRAWINGS

Illustrative embodiments of the present disclosure are described in detail below with reference to the attached drawing figures, which are incorporated by reference herein and wherein:

FIG. 1 is a schematic, perspective view of an illustrative embodiment of a gate valve utilizing a t-slot operational interface;

FIG. 2 is a schematic, perspective view with a portion shown in cross section of an illustrative embodiment of a gate valve utilizing a t-slot operational interface;

FIG. 3 is a schematic, cross-sectional view of a portion of an illustrative embodiment of a gate valve utilizing a t-slot operational interface;

FIG. 4 is a schematic, perspective view with a portion shown in cross section of a portion of an illustrative embodiment of a gate valve utilizing a t-slot operational interface;

FIG. 5 is a schematic, perspective view of an illustrative embodiment of a piston with a t-slot aperture;

FIG. 6 is a schematic, elevation view of an illustrative embodiment of a t-slot operating assembly including an operating stem, a piston, and a t-slot adapter; and FIG. 7 is a schematic, perspective view with a portion shown in cross section of a portion of an illustrative embodiment of a gate valve utilizing a t-slot operational interface having a hydraulic override port.

### DETAILED DESCRIPTION

In the following detailed description of the preferred embodiments, reference is made to the accompanying drawings that form a part hereof, and in which is shown, by way of illustration, specific embodiments in which the disclosure may be practiced. These embodiments are described in sufficient detail to enable those skilled in the art to practice the disclosure, and it is understood that other embodiments may be utilized, and that logical structural, mechanical, electrical, and chemical changes may be made without departing from the spirit or scope of the disclosure. To avoid detail not necessary to enable those skilled in the art to practice the disclosure, the description may omit certain information known to those skilled in the art. The following detailed description is, therefore, not to be taken in a limiting sense, and the scope of the present disclosure is defined only by the claims. Unless otherwise indicated, as used throughout this document, “or” does not require mutual exclusivity.

In one illustrative embodiment, a gate valve has a valve body with a through-bore running the length of the valve body. The through-bore being, typically, of circular cross section. The ends of the gate valve are connected to upstream and downstream tubulars, with fluid entering the gate valve from the upstream side and exiting the gate valve from the downstream side.

Flow is opened or closed by a gate. The gate is generally a slab with an opening in one area and a solid surface in another area. The gate resides within a gate cavity which bisects the through-bore and is able to be moved from an open position, in which the opening of the gate is in line with the through-bore, and a closed position, in which the solid surface of the gate blocks flow through the through-bore.

The gate is connected to a first end of an operator stem, which is at least partially disposed within the gate cavity. The second end of the operating stem is connected to a piston. The piston is connected to an operator. Activation of the operator results in moving the gate between the open position and the closed position. The operator acts on the piston causing it to move along the direction of orientation of the gate cavity, which, in turn results in movement of the operating stem in the same direction, which, in turn, results in movement of the gate within the gate cavity. In this manner, a user of the gate valve is able to open or block the flow of fluids through the through-bore using the operator. The operator may be any type of known operator including a manually turned operator, a hydraulic operator, an electric operator, or a pneumatic operator.

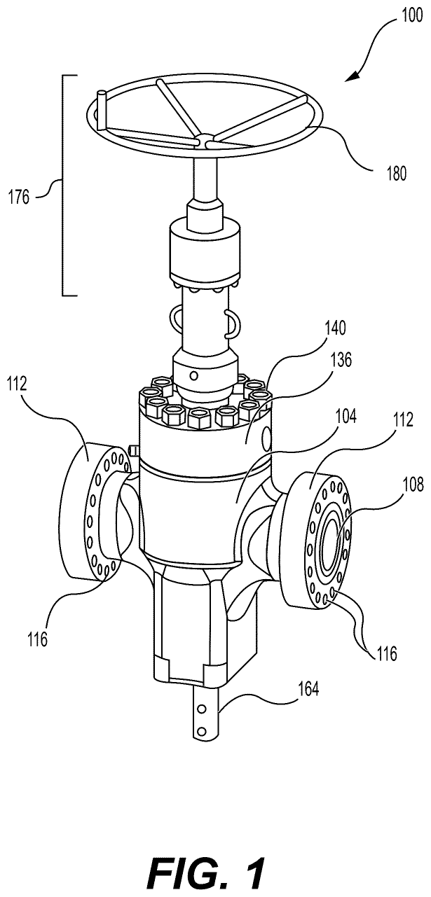

Referring now to the figures and primarily to FIG. 1, a gate valve 100 utilizing a t-slot operational interface will be described. A gate valve 100 has a valve body 104 that is formed with a through-bore 108 therethrough. The through-bore 108 allows for fluid flow through the gate valve 100 along the length of the through-bore 108. Flanges 112, which are formed on the valve body 104, are used to connect the gate valve 100 to upstream and downstream tubulars and the like to allow for fluid flow into or out of the gate valve 100 to pass into or out of the tubulars. The tubulars may be attached to the flanges 112 with studs and nuts or bolts using coupling holes 116.

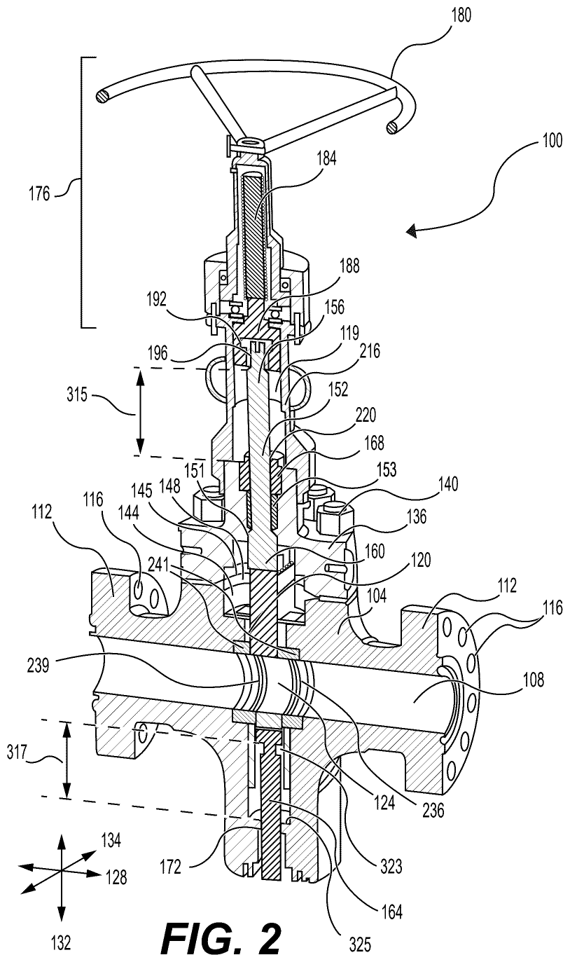

Referring now primarily to FIGS. 2-4, and initially to FIG. 2, a gate cavity 120 is formed within the valve body 104. The gate cavity 120 is orthogonal to and bisects the through-bore 108. A gate 124 is disposed within the gate cavity 120. The gate 124 is operable to translate in the second direction 132 along a length of the gate cavity 120 between an open position (as shown in FIG. 2) and a closed position. When the gate 124 is in the closed position fluid flow through the through-bore 108 is blocked by the gate 124, and when the gate 124 is in the open position, fluid flow within the through-bore 108 is not blocked by the gate 124. In the closed position, the gate 124 substantially blocks fluid flow through the through-bore 108. As used herein, “substantially blocking” fluid flow means that at least 98% of fluid flow is prevented from passing the gate 124. Seats 239 are disposed within seat cavities 241 proximate to each side of the gate 124. Seats 239 provide a body for the gate 124 to seal against when the gate 124 is in the closed position. The seats 239 may be dynamic seats, meaning that the seats 239 may have some degree of translation along direction 128 in response to through-bore pressure. The seats 239 may have energizers or springs to urge the seats 239 in direction 128 toward the gate 124 to improve sealing.

An upper bonnet 136 is attached to the valve body 104 by a plurality of bolts 140. Upper or lower designations as used herein are with reference to the orientation shown in the figures and used for orientation purposes and are not meant to be limiting. A cavity 145 within the lower portion of the upper bonnet 136 aligns with the gate cavity 120 to form an upper lubricant cavity 144. The upper lubricant cavity 144 contains grease or other lubricant to facilitate the movement of the gate 124 and other components within the gate cavity 120. The connection between the valve body 104 and the upper bonnet 136 is sealed by a bonnet gasket 148. An operator housing 216 is coupled to the upper bonnet 136. The operator housing 216 includes an interior cavity 119.

An upper operator stem 152 is at least partially disposed within the gate cavity 120, the interior cavity 119 of the operator housing 216, and the cavity 145 of the upper bonnet 136. A second end 160 of the upper operator stem 152 is attached to the gate 124. As described further below, the second end 160 of the upper operator stem 152 may be attached to the gate 124 by a t-slot connection in which the gate 124 has a tee that is sized and configured to be received into a t-slot of the upper operator stem 152 or the tee and the t-slot may be reversed between the gate 124 and the upper operator stem 152. A lower operator stem 164 is likewise attached to the gate 124. The upper operator stem 152 passes through an upper stem aperture 168 of the upper bonnet 136. The lower operator stem 164 passes through a lower stem aperture 172 of the valve body 104. In some embodiments, a lower operator stem 164 is not used or is referred to as a balance rod.

Actuation of either the upper operator stem 152 or the lower operator stem 164 by an operator assembly 176 may be used to move the gate 124 between the closed position and the open position to block or allow fluid flow through the through-bore 108, as desired. In the illustrative embodiment of FIGS. 1-4, an illustrative operator assembly 176 is shown attached to the upper operator stem 152. The lower operator stem 164 is shown without an operator assembly 176. When the lower operator stem 164 does not have an operator assembly 176 attached, the lower operator stem 164 may be referred to as a balance rod or balance stem. In other embodiments, both the upper operating stem 152 and the lower operator stem 164 have operator assemblies 176. In other embodiments only the lower operator stem 164 has an operator assembly 176. Again, the designation or upper or lower herein is only meant to provide orientation as depicted in the figures and as described herein.

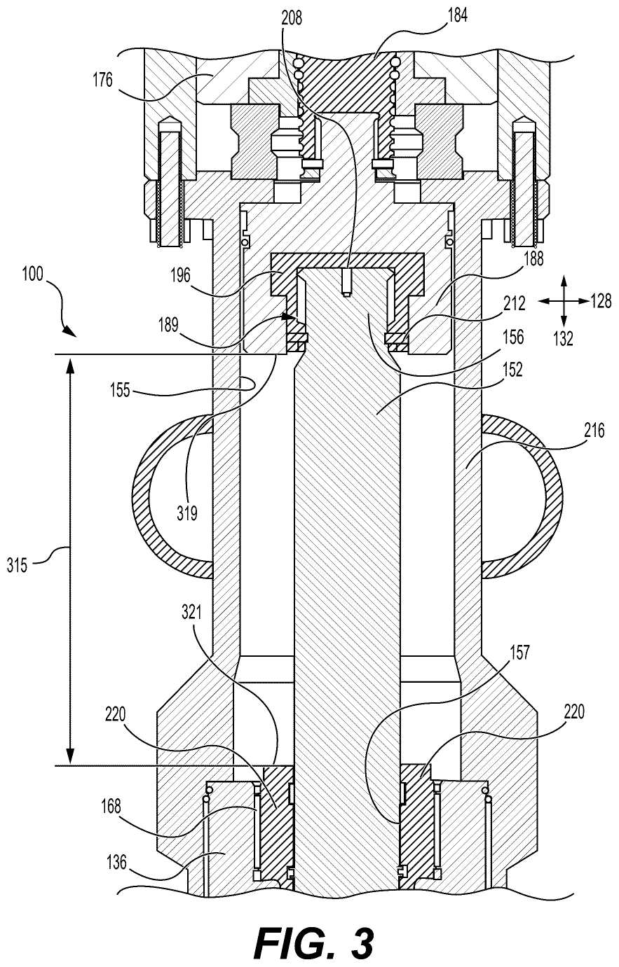

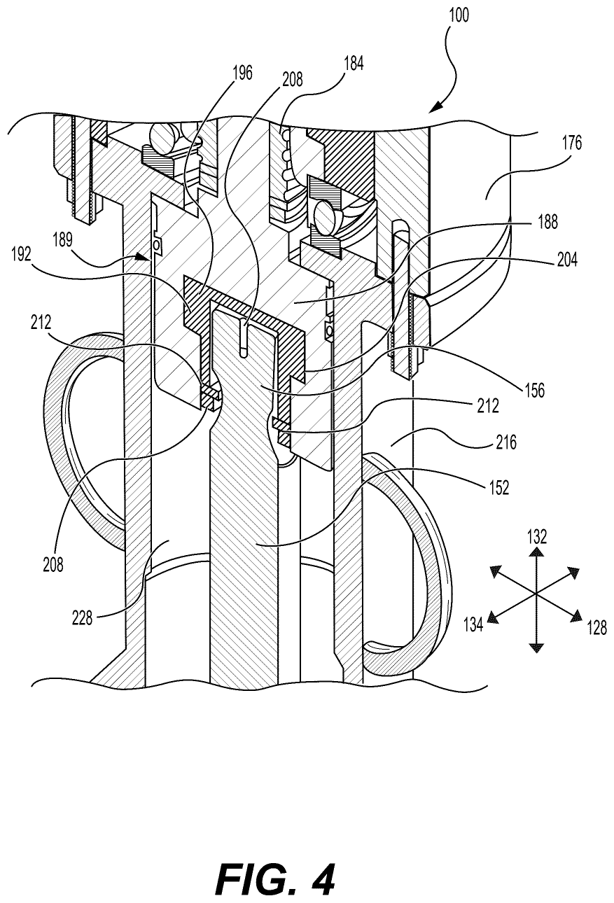

Referring to FIG. 2, the operator assembly 176 shown is a manually operated operator assembly. The operator assembly 176 is actuated by turning a handle 180. Turning the handle 180 causes the operator screw 184 to spin and moving either up or down the second direction 132, depending on which way the handle 180 is turned. Movement of the operator screw 184 along second direction 132 causes a piston 188 to move along with and in the same direction as the operator screw 184. As can be seen in the details of FIGS. 3 and 4, the piston 188 is attached to the first end 156 of the upper operator stem 152. Therefore, the upper operator stem 152 also moves in the second direction 132 along with the piston 188 and the operator screw 184.

The connection between the piston 188 and the upper operator stem 152 of the gate valve 100 is a t-slot operational interface 189, which will be more fully described below. As described above, the second end 160 of the upper operator stem 152 is attached to the gate 124. Therefore, movement of the upper operator stem 152 along the second direction 132 also results in movement of the gate 124 in the second direction 132 in the same direction as the upper operator stem 152. In this manner, the gate 124 is moved within the gate cavity 120 along the second direction 132 by actuation of the operator assembly 176. The second end of the upper operator stem 152 may be coupled to the gate 124 using a tee and t-slot connection.

It should be noted that the manual operator assembly 176 depicted in FIGS. 1-4 is meant to be illustrative. Other embodiments use other types of operators, such as hydraulic operators or electric operators, which function to open and close the gate valve 100. In other embodiments, one type of operator assembly 176 is attached to the upper operator stem 152 and a different type of operator assembly 176 is attached to the lower operator stem 164.

The connection between the piston 188 and the upper operator stem 152 of the gate valve 100 is a t-slot operational interface 189, which will be more fully described below.

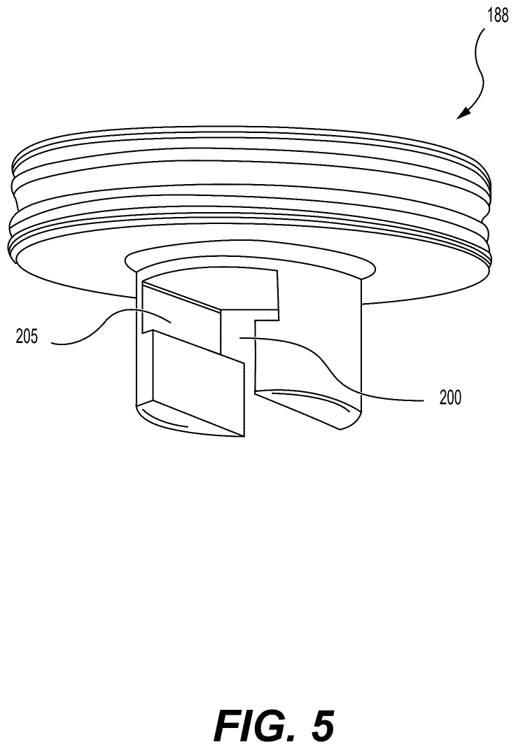

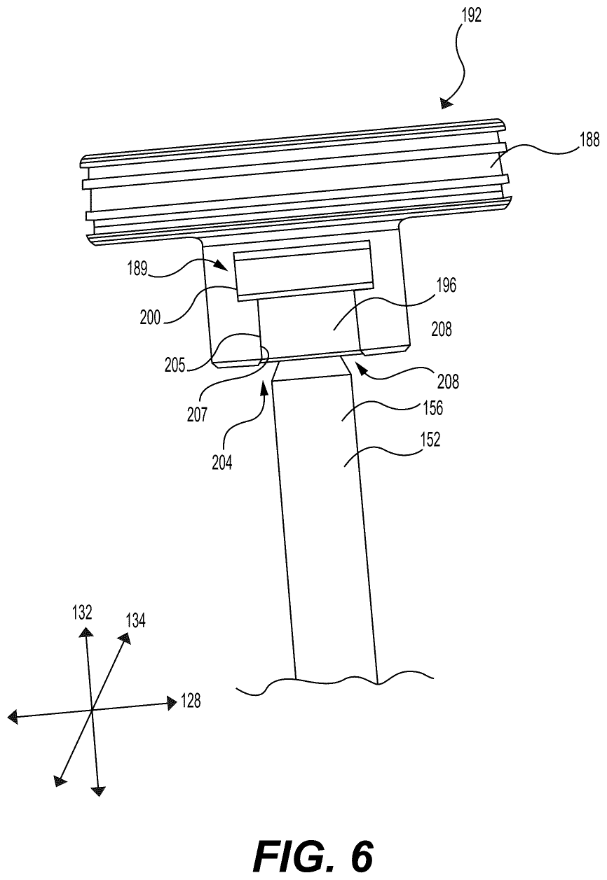

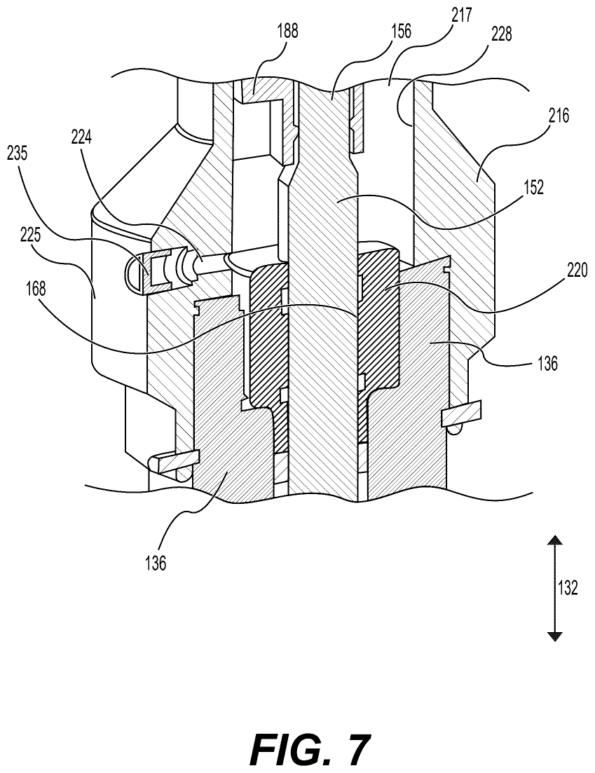

Referring now primarily to FIGS. 5-6, the t-slot operational interface 189 between the piston 188 and the upper operator stem 152 of the gate valve 100 will be more fully described. FIG. 6 depicts an illustrative embodiment of a t-slot operating assembly 192. The t-slot operating assembly 192 includes the piston 188, the upper operating stem 152, and a t-slot adapter 196. FIG. 5 depicts the piston 188. It should be noted that piston 188 of FIGS. 5 and 6 differs slightly from piston 188 of FIGS. 1-4. This is because FIGS. 1-4 utilize a manual operator assembly 176, which requires coupling of the operator screw 184 to the piston 188. The illustrative embodiment of FIGS. 5 and 6, depict the piston 188 that is utilized in a hydraulically operated operator assembly 176. Since, in this case, the piston 188 is driven by hydraulic fluid, the connection to an operator screw 184 is not used. The t-slot operational interface 189 and the t-slot operating assembly 192 may be used with either piston 188 configuration or with other piston configurations for operator assemblies 176 that are actuated in other manners.

The piston 188 has a t-slot aperture 200. The t-slot aperture 200 is an opening within the piston 188 that is formed with a tee shape. The t-slot adapter 196 has an exterior surface that is tee shaped and that is sized and configured to be received by the t-slot aperture 200 of the piston 188. The t-slot adapter 196 can, therefore, be inserted into the t-slot aperture 200 of the piston 188 and, thereby, the t-slot adapter 196 is captured and attached to the piston 188. The sizes and configurations of the t-slot aperture 200 and of the t-slot adapter 196 can be modified to adjust the tightness of the fit between the t-slot aperture 200 and the t-slot adapter 196. For example, the size of a gap 204 between an interior wall 205 of the piston 188 and an exterior wall 207 of the t-slot adaptor 196 may be adjusted to increase or decrease the freedom of movement of the t-slot adaptor 196 within the t-slot aperture 200. Preferably the gap 204 is small enough that the t-slot adaptor 196 remains captured within the t-slot aperture 200 by the tee features of the t-slot adaptor 196 and the t-slot aperture 200 but at the same time is large enough to allow some movement of the t-slot adapter 196 within the t-slot aperture 200. In this manner, the t-slot adapter 196 is captured by the piston 188 yet remains free floating with some degree of movement within the t-slot aperture 200.

In some embodiments, the t-slot adapter 196 is able to move within the t-slot aperture 200 in the direction 128 or the direction 134 in the range of 0.010″-0.050″. In some embodiments, the t-slot adapter 196 is able to move within the t-slot aperture 200 in the direction 128 or the direction 134 sufficiently to take up any linear misalignments within the assembled components to ensure freedom of travel and to prevent unnecessary torque additions to the components.

In some embodiments the t-slot operational interface 109 is reversed where the piston 188 has a tee shape that is sized and configured to be received by a t-slot located on the t-slot adapter 196. Furthermore, other sized and shaped connections may be used to attach the piston 188 and an adapter 196 other than a t-slotted connection that still allow for the herein described freedom of movement of the adapter 196 or the upper operator stem 152 relative to the piston 188.

The t-slot adapter 196 also has a lower aperture 208. The lower aperture 208 is sized and configured to receive and attach to the first end 156 of the upper operator stem 152.

The first end 156 of the upper operator stem 152 may be inserted into the lower aperture 208 and attached to the t-slot adapter 196 by set screws 212 (FIG. 3). In other embodiments, the upper operator stem 152 is attached to the t-slot adapter 196 with a threaded connection. In other embodiments the upper operator stem 152 is attached to the t-slot adapter 196 with pins or other methods.

Since the t-slot adapter 196 is free floating within the t-slot aperture 200 with some degree of movement and the upper operator stem 152 is attached to the t-slot adapter 196, the upper operator stem 152 also has the same degree of movement. As used herein, “free floating” refers to the t-slot adapter 196 having some degree of movement within the t-slot aperture 200 while still being retained by the t-slot aperture 200. In some embodiments, the t-slot adapter 196 is able to move in the first direction 128 within the t-slot aperture 200, which is perpendicular to a length of the upper operator stem 156, or in the third direction 134 within the t-slot aperture 200, which is also perpendicular to a length of the upper operator stem 156. In some embodiments, the t-slot adapter 196 is able to move in the first direction 128 and in the third direction 134 within the t-slot aperture 200.

When assembled within the gate valve 100 and the operator assembly 176 is used to move the gate 124 between the open or closed position, the t-slot operating assembly 192, including the piston 188, the t-slot adapter 196, and the upper operator stem 156 move in the second direction 132, which is required to open or close the gate 124 (FIG. 2). The t-slot adapter 196 and, therefore, also the upper operating stem 152, however, have a degree of freedom of movement in the first direction 128 or the third direction 134. The t-slot adapter 196 is able to move in the third direction 134 by sliding through the t-slot aperture 200 of the piston 188. The amount of the degree of freedom of movement in the first direction 128 is controlled by the size of the gap 204. A larger gap 204 provides a larger degree of freedom of movement in the first direction 128, and a smaller gap 204 provides a lower degree of freedom of movement in the first direction 128.

As shown in FIGS. 2 and 3, the upper operator stem 152 and the t-slot operating assembly 192 contact multiple surfaces within the gate valve 100. For example, the upper operator stem 152 contacts inner surfaces 151 or seals 153 of the upper bonnet 136; the piston 188 contacts an inner wall surface 155 of the operator housing 216; and the upper operator stem 152 contacts an inner wall 157 of a block 220.

During actuation of the gate valve 100, the components of the t-slot operating assembly 192 must be able to freely slide along the surfaces of the various components that the t-slot operating assembly 192 contacts when the gate valve 100 is changed from closed to open or vice versa. If these components are not able to slide freely while in contact with each other damage may occur to the gate valve 100. Dimensional misalignment with closely mated components and dimensional shifting of components of the gate valve 100, which both may occur with extended use of the gate valve 100, may result in excessive friction between components, the need for excessive force to operate the gate valve 100, or the failure of the gate valve 100 to operate at all. Other damage may also occur, for example, excessive friction between the upper operating stem 152 and another component may cause galling of the operating stem or other component.

The degree of freedom, described above, of the t-slot adapter 196 and the upper operator stem 152 may alleviate or reduce the problems caused by tightly fitted components, dimensional misalignment with closely mated components, dimensional shifting of components of the gate valve 100, and similar dimensional fit problems between components of the gate valve 100. As the gate valve 100 is operated, the upper operator stem 152 is able to move, to some degree, in the first direction 128 and the third direction 134 as the upper operator stem 152 translates along the second direction 132. This degree of freedom of movement in the first direction 128 and the third direction 134 allow the upper operating stem 152 to move in response to excessive friction or contact with other components of the gate valve 100. This in turn, reduces the possibility of galling or otherwise damaging the components to the gate valve 100 while operating the gate valve 100.

While the illustrative embodiments of the gate valve 100 using a t-slot operational interface 189 depicted herein utilize a t-slot adapter 196 to connect the upper operator stem 152 to the piston 188, this is not required in other embodiments. For example, in other embodiments the first end 156 of the upper operator stem 152 may be formed with a tee shape that is sized and configured to mate directly with the t-slot aperture 200 of the piston 188.

Referring now primarily to FIG. 7, another illustrative embodiment of the gate valve 100 using a t-slot operational interface will be discussed. This embodiment is analogous to the above previously described embodiments in most respects but includes additional features. In the illustrative embodiment of FIG. 7, as described above in relation to other embodiments, the upper operator stem 152 is attached on the second end 160 to the gate 124, and the first end 156 of the upper stem 152 is attached to the piston 188. The upper operator stem 152 passes through the upper stem aperture 168 of the upper bonnet 136 and is secured within the upper stem aperture 168 by the block 220. The operator housing 216 is attached to the exterior of the upper bonnet 136. In this manner, a chamber 228 is formed between the piston 188, the interior walls 217 of the operator housing 216 and the block 220. As the gate valve 100 is operated from open to close or vice versa the volume of the chamber 228 changes. Lowering the upper stem 152 and piston 188 in the second direction 132 results in a decrease in the volume of the chamber 228. Conversely, raising the upper stem 152 and the piston 188 in the second direction 132 increases the volume within the chamber 228.

A port 224 is located in the operator housing 216, when open the port 224 allows for fluid communication between the chamber 228 and the exterior of the operator housing 216. The port 224 can be used for at least two purposes. First, the port 224 can act as a breather vent or valve to allow air flow between the chamber 228 and the exterior of the operator housing 216. In this manner, the port 224 allows for air flow between the chamber 228 and the exterior of the operator housing 216 to allow for pressure equalization to account for the volume changes to chamber 228 during operation of the valve 100. Secondly, the port 224 can serve the purpose of a hydraulic or pneumatic back up actuation method for the gate valve 100. In some configurations, when the gate valve 100 is in the closed position, the volume within chamber 228 is relatively smaller because the piston 188 is moved toward the through-bore 108 when the gate valve 100 is closed. Conversely, the volume of the chamber 228 is relatively larger when the gate valve 100 is open because when the gate 124 is in the open position, the piston 188 is moved further away from the through-bore 108. The port 224 may be closed or covered by a cap or plug 235 when not in use.

If the gate valve 100 is in the closed position and the operator assembly 176 is stuck or the gate valve 100 needs to be opened immediately due to a situation such as an emergency, then the port 224 can act as a hydraulic backup actuation port. When the port 224 is used in this manner, a source of fluid or gas under pressure is attached to the port 224 on the exterior 225 of the operator housing 216. Pressurized fluid or gas is then introduced into the chamber 228 through the port 224. This results in an increase in pressure within the chamber 228. The increase in pressure acts on the piston 188 to force the piston 188 upwards (away from the through-bore), which in turn results in the gate valve 100 going from closed to open and, therefore, allows fluid flow through the through-bore 108.

In other configurations, the port 224 may be used to manually operate the gate valve 100 in an analogous manner to open a closed gate valve 100.

In other embodiments, the port 224 may be located on a lower operator housing if the gate valve 100 includes an operator assembly 176 coupled to the lower operator stem 164, or in a lower bonnet, if used, or valve body 104 proximate to the lower stem. In an analogous manner, the port 224 may be used to provide both venting and hydraulic or pneumatic override of the opening or closing mechanism of the gate valve 100.

In other embodiments, the port 224 may be used to prevent self actuation of the gate valve 100. Self actuation may occur in manually operated gate valves 100, where the weights of the drive train of the operator assembly 176 causes the operator assembly to self actuate, i.e., gravity pulls the drive train of the operator assembly 176 downward to move the gate 124 from an open to a closed position or from a closed to an open position. The cap 235 may be a sealed cap, meaning the once installed into the port 224, the cap 235 creates an airtight condition within chamber 228. Since air cannot flow out of the chamber 228 in this configuration, self actuation may be prevented by the air pressure within the chamber 228.

In some embodiments of gate valve 100, a port 224 is used without the herein described t-slot operational interface 189. In some embodiments, a port 224 is located both the lower operator housing, lower bonnet, or lower valve body 104 and in the operator housing 216. In this manner the ports 224 may be used to both change the state of the gate valve 100 from opened to closed and from closed to opened.

Referring now to FIGS. 2 and 3, additional features of an illustrative embodiment of the gate valve 100 will be discussed. As discussed above, operation of the operator assembly 176 results in the collective and coordinated movement of the piston 188, upper stem 156, gate 124, and lower stem 164 in the direction 132. The total length of possible movement of the combined components is determined by the shortest length of travel available for the components to move within. In the embodiment of FIG. 2, a length 315 exists regarding the possible range of movement related to the upper stem 156. The length 315 is defined by the distance between a lower surface 319 of the piston 188 and an upper surface 321 of the block 320 (FIG. 3).

In the embodiment of FIG. 2, a length 317 also exists in relation to the possible range of movement related to the lower stem 164. The length 317 is defined by the distance between a bottom surface 323 of the lower stem 164 and an upper surface 323 of the valve body 204 or, if used, a lower bonnet. In other embodiments and other configurations, the length 317 may be determined by other components proximate to the lower stem 164.

The total distance the combined piston 188, upper stem 156, gate 124, and lower stem 164 may move in the direction 132 is determined by the shorter of the length 315 or the length 317. It is desirable for the total distance the combined piston 188, upper stem 156, gate 124, and lower stem 164 may move in the direction 132 to be determined by the length 315. If the length 315 is shorter than the length 317 then travel of the piston 188, upper stem 156, gate 124, and lower stem 164 in the direction 132 will stop when the lower surface 319 of the piston 188 contacts the upper surface 321 of the block 220. In addition, in this configuration, the bottom surface 323 of the lower stem 164 does not contact the upper surface 323 of the valve body 104. This is desirable to prevent the gate 124 from bottoming out within the gate valve 100. Since, the lower half of the collective piston 188, upper stem 156, gate 124, and lower stem 164 has not bottomed out, movement of the gate 124 in the direction 128, which may be caused by fluid pressures within the through-bore 108, is still possible.

If the total distance the combined piston 188, upper stem 156, gate 124, and lower stem 164 may move in the direction 132 is determined by the length 317, i.e., the length 317 is shorter than the length 315, then movement of the combined piston 188, upper stem 156, gate 124, and lower stem 164 will stop when the bottom surface 323 of the lower stem 164 and the upper surface 323 of the valve body 104 come into contact with each other. This contact will effectively cause the gate 124 to bottom out because the gate 124 is pinched between the upper stem 156 and the lower stem 164. Since the lower stem 164 cannot further travel downwards along length 132, neither can the gate 124. This configuration prevents the gate 124 from being able to move along the direction 128 in response to through-bore fluids. This, in turn, reduces the effectiveness of the seal achieved by the gate 124 to prevent flow of fluids through the through-bore 108. In this configuration, once the gate 124 is bound and operation of the operator assembly 176 must be reversed to back of the gate 124 to allow for movement of the gate 124 in the direction 128.

There are many examples of the various embodiments described herein. A number of examples also follow:

Example 1. A gate valve comprising:
a valve body, wherein the valve body is formed with a through-bore therethrough and a gate cavity and wherein the through-bore and the gate cavity intersect and are orthogonal to each other;
a gate disposed within the gate cavity, wherein the gate is operable to translate along a length of the gate cavity to move between an open position and a closed position, wherein when the gate is in the closed position the gate substantially blocks fluid flow through the through-bore and when the gate is in the open position the gate does not substantially block fluid flow through the through-bore; and
an t-slot operating assembly comprising
   an operating stem having a first end and a second end, wherein the second end is coupled to the gate,
   a piston having a t-slot aperture, and
   a t-slot adapter having an aperture sized and configured to receive the first end of the operating stem and having an external t-shape sized and configured to be received within the t-slot aperture of the piston, and
   wherein the t-slot adapter is captured by the t-slot aperture whereby the t-slot adapter is free floating within the t-slot aperture of the piston.

Example 2. The gate valve of Example 1, wherein the second end of the operating stem is connected to the gate using a t-slot connection.

Example 3. A gate valve comprising:
a valve body, wherein the valve body is formed with a circular through-bore therethrough and a gate cavity and wherein the through-bore and the gate cavity intersect and are orthogonal to each other;
a gate disposed within the gate cavity, wherein the gate is operable to translate along a length of the gate cavity to move between an open position and a closed position, wherein when the gate is in the closed position the gate substantially blocks fluid flow through the through-bore and when the gate is in the open position the gate does not substantially block fluid flow through the through-bore;
an operating stem at least partially disposed within the gate cavity and attached to the gate;
a piston attached to the operating stem;
an operator attached to the piston;
wherein the operator is operable to move the gate between the open position and the closed position;
wherein the operating stem is attached to the piston with a t-slot connection.

The gate valve of Example 3, wherein the operating stem is connected to the gate using a t-slot connection.

Although the present disclosure and its advantages have been disclosed in the context of certain illustrative, non-limiting embodiments, it should be understood that various changes, substitutions, permutations, and alterations can be made without departing from the scope of the disclosure as defined by the claims. It will be appreciated that any feature that is described in a connection to any one embodiment may also be applicable to any other embodiment.

1. A gate valve comprising:
a valve body, wherein the valve body is formed with a through-bore therethrough and a gate cavity and wherein the through-bore and the gate cavity intersect and are orthogonal to each other;
a gate disposed within the gate cavity, wherein the gate is operable to translate along a length of the gate cavity to move between an open position and a closed position;
wherein when the gate is in the closed position, the gate substantially blocks fluid flow through the through-bore and when the gate is in the open position the gate does not substantially block fluid flow through the through-bore; and
a t-slot operating assembly at least partially disposed within the gate cavity comprising:
an operating stem having a first end and a second end, wherein the second end is coupled to the gate,
a piston having a t-slot aperture, and
a t-slot adapter at least partially disposed within the t-slot aperture, the t-slot adapter having an aperture sized and configured to receive the first end of the operating stem and having an external t-shape sized and configured to be received within the t-slot aperture of the piston.

2. The gate valve of claim 1, wherein the t-slot adapter is captured by the t-slot aperture whereby the t-slot adapter is free floating within the t-slot aperture of the piston.

3. The gate valve of claim 1, further comprising:
an upper bonnet, having a first end and a second end, wherein the second end of the upper bonnet is coupled to the valve body;
a block coupled to the first end of the upper bonnet having a stem aperture formed therein;
wherein the operating stem is slidably disposed within the stem aperture of the block; and
wherein the t-slot adapter is captured by the t-slot aperture whereby the t-slot adapter is free floating within the t-slot aperture of the piston.

4. The gate valve of claim 1, further comprising an operator assembly coupled to the piston, wherein the operator assembly is operable to move the gate between the open position and the closed position.

5. The gate valve of claim 4, wherein the operator assembly is a manual operator assembly.

6. The gate valve of claim 1 further comprising:
an upper bonnet, having a first end and a second end, wherein the second end of the upper bonnet is coupled to the valve body;
a block coupled to the first end of the upper bonnet having a stem aperture formed therein; and
wherein the operating stem is slidably disposed within the stem aperture of the block.

7. The gate valve of claim 6, wherein a maximum distance of travel of the gate is equal to a distance between a surface of the piston and a surface of the block.

8. The gate valve of claim 1, wherein the t-slot adapter is captured by the t-slot aperture whereby the t-slot adapter is able to move within the t-slot aperture in at least two directions that are perpendicular to a length of the operating stem.

9. A gate valve comprising:
a valve body, wherein the valve body is formed with a circular through-bore therethrough and a gate cavity and wherein the through-bore and the gate cavity intersect and are orthogonal to each other;
a gate disposed within the gate cavity, wherein the gate is operable to translate along a length of the gate cavity to move between an open position and a closed position, wherein when the gate is in the closed position the gate substantially blocks fluid flow through the through-bore and when the gate is in the open position the gate does not substantially block fluid flow through the through-bore;
an upper operating stem at least partially disposed within the gate cavity and attached to the gate;
a piston attached to the upper operating stem;
an operator attached to the piston;
wherein the operator is operable to move the gate between the open position and the closed position; and
wherein the upper operating stem is attached to the piston with a t-slot connection.

10. The gate valve of claim 9, further comprising a lower operating stem attached to the gate.

11. The gate valve of claim 9, wherein the operator is a manual operator.

12. The gate valve of claim 9, wherein the t-slot connection between the upper operating stem and the piston allows for the upper operating stem to be free floating relative to the piston.

13. The gate valve of claim 9, wherein the upper operating stem is able to move relative to the piston in at least two directions that are perpendicular to a length of the upper operating stem.

14. The gate valve of claim 9, wherein the piston is coupled to the upper operating stem by a t-slot adapter.

15. The gate valve of claim 14, wherein the upper operating stem is partially disposed within an aperture of the t-slot adapter;
wherein the t-slot adapter has a cross-sectional t-shaped portion;
wherein the piston has a t-shaped aperture sized and configured to receive the t-slot adapter; and
wherein, when the t-slot adapter is disposed within the t-shaped aperture, the t-slot adapter is free floating within the t-slot aperture.

16. The gate valve of claim 14,
wherein the upper operating stem is partially disposed within an aperture of the t-slot adapter;
wherein the t-slot adapter has a cross-sectional t-shaped portion;
wherein the piston has a t-shaped aperture sized and configured to receive the t-slot adapter; and
wherein, when the t-slot adapter is disposed within the t-shaped aperture, the t-slot adapter is able to move within the t-shaped aperture in at least one direction that is perpendicular to a length of the upper operating stem.

17. The gate valve of claim 16, wherein the t-slot adapter is able to move within the t-shaped aperture in two directions that are perpendicular to the length of the upper operating stem.

18. A gate valve comprising:
a valve body having a through-bore formed therethrough in a first direction and having a gate a cavity formed there through in a second direction, wherein the gate cavity and the through-bore are substantially perpendicular to each other, and wherein the gate cavity and the through-bore intersect with each other;
an upper bonnet coupled to the valve body, having an interior cavity;
an operator housing coupled to the upper bonnet having an interior cavity;
a gate slidably disposed within the gate cavity;
a piston, at least partially disposed within the interior cavity of the operator housing;
wherein the piston has a first end and a second end;
an operator assembly coupled to the first end of the piston;
an operating stem, at least partially disposed within the gate cavity, the upper bonnet interior cavity, and the operator housing interior cavity, wherein a first end of the operating stem is coupled to the second end of the piston and a second end of the operating stem is coupled to the gate; and
wherein the operating stem is coupled to the piston with a free floating connection.

19. The gate valve of claim 18,
wherein the piston is coupled to the operating stem by a t-slot adapter;
wherein the operating stem is partially disposed within an aperture of the t-slot adapter;
wherein the t-slot adapter has a cross-sectional t-shaped portion;
wherein the piston has a t-shaped aperture sized and configured to receive the t-slot adapter; and
wherein, when the t-slot adapter is disposed within the t-shaped aperture, the t-slot adapter is able to move within the t-shaped aperture in at least one direction that is perpendicular to a length of the operating stem.

20. The gate valve of claim 18, further comprising a manual override port formed within the operator housing to allow for fluid communication between the interior cavity of the operator housing and an exterior of the gate valve; and
wherein the gate valve may be, at least partially, actuated by pressurizing the interior of the operating housing by introducing a pressurized fluid or gas into the interior of the operating housing through the manual override port.
